(19) United States
(12) Patent Application Publication
(10) Pub. No.: US 2022/0005230 A1
(43) Pub. Date: Jan. 6, 2022

(54) Point Cloud Encoding and Decoding Methods, Encoding Device and Decoding Device

(71) Applicant: Pekjng University Shenzhen Graduate School, Guangdong (CN)

(72) Inventors: Ge LI, Guangdong (CN); Honglian WEl, Guangdong (CN); Yiting SHAO, Guangdong (CN)

(21) Appl. No.: 17/279,177

(22) PCT Filed: Mar. 28, 2019
(86) PCT No.: PCT/CN2019/079980

§ 371 Date: Mar. 24, 2021

(30) Foreign Application Priority Data
Mar. 20, 2019 (CN) 201910214173.6

(51) Int. Cl. G06T 9/00; G06T 7/73

(52) U.S. Cl. CPC G06T 9/001; G06T 7/75

(57) ABSTRACT

Provided by the present invention are point cloud encoding and decoding methods, an encoding device and a decoding device. The method comprises: determining a point set composed of K nearest neighbor points of a current point; determining a point set composed of L next nearest neighbor points of the current point; determining a preferred nearest neighbor point set of the current point according to the point set composed of K nearest neighbor points of the current point and the point set composed of L next nearest neighbor points of the current point; and performing encoding according to the preferred nearest neighbor point set of the current point. Therefore, point cloud encoding performance may be improved by means of selecting a neighbor point set having an appropriate distribution.

### TECHNICAL FIELD

The present invention relates to the field of point cloud processing, and more particularly relates to point cloud encoding and decoding methods, an encoding device and a decoding device.

### BACKGROUND ART

Point cloud is a set of discrete points that are irregularly distributed in space and express a spatial structure and surface attributes of a three-dimensional object or scene. Each point in the point cloud at least has three-dimensional location information and may also have color, material quality or other information according to different application fields. Generally, each point in the point cloud has the same number of additional attributes.

The three-dimensional point cloud is an important digital expression of the real world. With the rapid development of three-dimensional scanning devices (laser, radar, etc.), the precision and resolution of the point cloud are higher. The high-precision point cloud is widely applied to the construction of urban digital maps and plays a role of technical support in a lot of hot researches such as smart cities, unmanned driving, cultural relics protection, etc. The point cloud is acquired by scanning surfaces of objects by the three-dimensional scanning device. A frame of point cloud generally contains millions of points. Each point contains geometric information, color, reflectivity and other attribute information, and is huge in amount of data. The huge data amount of the three-dimensional point cloud brings great challenges to data storage, transmission, etc., so the point cloud compression is very necessary.

The point cloud compression is mainly classified into geometric compression and attribute compression. At present, point cloud attribute compression frameworks described in the test platform TMC13v5 (Test Model for Category 1&3 version 5) provided by the International Standard Organization MPEG (Moving Picture Experts Group) mainly include:

I, Lifting strategies based on LOD (level of Detail): this method first uses the point cloud already sequenced according to Morton codes to construct the LOD, that is, a distance threshold is set in advance for each layer of LOD, all points in the point cloud are traversed, the points satisfying the threshold condition are added into the current LOD, and then the points that should be added into the next layer of LOD are judged in a same method until the entire LOD is constructed. Three nearest neighbor points are found in the LOD sequence for the points in the point cloud according to a KNN algorithm, and a weighted mean of attribute values of all 3 nearest neighbor points is used as a predicted value.

II, Intra-frame prediction mode decision methods based on LOD: the process of constructing the LOD by this method is same as described in I. After the LOD is constructed, at most three neighbors are found for the current point according to the KNN algorithm, so there are 3+1 prediction modes in total, which are: the weighted mean of the attribute values of the three neighbors is used as a candidate predicted value, and the attribute values of the first neighbor, the second neighbor and the third neighbor are used as the candidate predicted values. A ROD cost value is calculated for the 3+1 predicted values and corresponding modes. The predicted value corresponding to the minimum cost value is used as the predicted value of the current point.

However, the above technologies predict the attribute value by only considering the distance when determining the neighbor points, and the neighbor points may be distributed at the same side of the current point, resulting in low prediction accuracy, thereby reducing the encoding and decoding performance.

### SUMMARY OF THE INVENTION

The present invention provides point cloud encoding and decoding methods, an encoding device and a decoding device, which can improve the point cloud encoding and decoding performance by means of selecting a neighbor point set having an appropriate distribution.

In a first aspect, provided by the present invention is a point cloud encoding method, which comprises: determining a point set composed of K nearest neighbor points of a current point; determining a point set composed of L next nearest neighbor points of the current point; determining a preferred nearest neighbor point set of the current point according to the point set composed of K nearest neighbor points of the current point and the point set composed of L next nearest neighbor points of the current point; and performing encoding according to the preferred nearest neighbor point set of the current point.

In conjunction with the first aspect, in a first possible implementation of the first aspect, determining the point set composed of K nearest neighbor points of the current point comprises: determining the point set composed of K nearest neighbor points of the current point according to a spatial distance from points in the point cloud to the current point.

In conjunction with the first aspect and the first possible implementation of the first aspect, in a second possible implementation of the first aspect, determining the point set composed of L next nearest neighbor points of the current point comprises: determining the point set composed of L next nearest neighbor points of the current point according to the spatial distance from the points in the point cloud to the current point.

In conjunction with the first aspect and the first to the second possible implementations of the first aspect, in a third possible implementation of the first aspect, determining the preferred neighbor point set of the current point according to the point set composed of K nearest neighbor points of the current point and the point set composed of L next nearest neighbor points of the current point comprises: determining a distance from a center of the point set composed of K nearest neighbor points of the current point to the current point as a first distance; determining a distance from a center of a point set composed of a total of K-H+I points (i.e. K-H nearest neighbor points in the point set composed of K nearest neighbor points of the current point and I next nearest neighbor points in the point set composed of L next nearest neighbor points of the current point) to the current point as a second distance; and determining the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when a difference between the first distance and the second distance is greater than a set value, or determining the point set composed of K nearest neighbor points of the current point as the preferred neighbor point set of the current point when the difference between the first distance and the second distance is less than or equal to the set value.

In conjunction with the first aspect and the first to the second possible implementations of the first aspect, in a fourth possible implementation of the first aspect, determining the preferred neighbor point set of the current point according to the point set composed of K nearest neighbor points of the current point and the point set composed of L next nearest neighbor points of the current point comprises: determining the distance from the center of the point set composed of K nearest neighbor points of the current point to the current point as the first distance; determining the distance from the center of the point set composed of a total of K-H+I points (i.e. K-H nearest neighbor points in the point set composed of K nearest neighbor points of the current point and I next nearest neighbor points in the point set composed of L next nearest neighbor points of the current point) to the current point as the second distance; determining the point set composed of K nearest neighbor points of the current point as the preferred neighbor point set of the current point when the difference between the first distance and the second distance is less than or equal to the set value, or when the difference between the first distance and the second distance is greater than the set value: determining a minimum cost value of the point set composed of K nearest neighbor points of the current point as a first cost value; determining a minimum cost value of the point set composed of a total of K-H+I points (i.e. K-H nearest neighbor points in the point set composed of K nearest neighbor points of the current point and I next nearest neighbor points in the point set composed of L next nearest neighbor points of the current point) as a second cost value; determining the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when the second cost value is less than the first cost value, or determining the point set composed of K nearest neighbor points of the current point as the preferred neighbor point set of the current point when the second cost value is greater than or equal to the first cost value.

In conjunction with the third possible implementation of the first aspect, in a fifth possible implementation of the first aspect, performing encoding according to the preferred neighbor point set of the current point comprises: determining a weighted mean of reconstructed attribute values of all points in the preferred neighbor point set of the current point as a candidate predicted value 1, and determining the corresponding mode as a prediction mode 1; sequentially determining the reconstructed attribute values of all points in the preferred neighbor point set of the current point as candidate predicted value 2 to candidate predicted value N+1, and sequentially determining the corresponding modes as the prediction mode 2 to prediction mode N+1, wherein N is the number of points in the point set; calculating the cost value Jn of the prediction mode 1 to the prediction mode N+1, wherein n is from 1 to N+1, determining the minimum value in Jn as the minimum cost value, and determining the corresponding mode of the minimum cost value as an preferred prediction mode; determining the predicted value of the current point according to the preferred prediction mode; determining a predicted residual of the current point according to a difference between the attribute value of the current point and the predicted value of the current point; and encoding the preferred prediction mode and the predicted residual.

In conjunction with the fourth possible implementation of the first aspect, in a sixth possible implementation of the first aspect, performing encoding according to the preferred neighbor point set of the current point comprises: determining the weighted mean of the reconstructed attribute values of all points in the preferred neighbor point set of the current point as the candidate predicted value 1, and determining the corresponding mode as the prediction mode 1; sequentially determining the reconstructed attribute values of all points in the preferred neighbor point set of the current point as the candidate predicted value 2 to candidate predicted value N+1, and sequentially determining the corresponding modes as the prediction mode 2 to prediction mode N+1, wherein N is the number of points in the point set; calculating the cost value Jn of the prediction mode 1 to the prediction mode N+1, wherein n is from 1 to N+1, determining the minimum value in Jn as the minimum cost value, and determining the corresponding mode of the minimum cost value as the preferred prediction mode; determining the predicted value of the current point according to the preferred prediction mode; determining the predicted residual of the current point according to the difference between the attribute value of the current point and the predicted value of the current point; and encoding the preferred prediction mode and the predicted residual when the difference between the first distance and the second distance is less than or equal to the set value, or encoding a valid replacement flag, the preferred prediction mode and the predicted residual when the difference between the first distance and the second distance is greater than the set value, and the second cost value is less than the first cost value, or encoding an invalid replacement flag, the preferred prediction mode and the predicted residual when the difference between the first distance and the second distance is greater than the set value and the second cost value is greater than or equal to the first cost value.

In a second aspect, provided by the present invention is a point cloud decoding method, which comprises: determining a point set composed of K nearest neighbor points of a current point; determining a point set composed of L next nearest neighbor points of the current point; determining a preferred nearest neighbor point set of the current point according to the point set composed of K nearest neighbor points of the current point and the point set composed of L next nearest neighbor points of the current point; and performing decoding according to the preferred nearest neighbor point set of the current point.

In conjunction with the second aspect, in a first possible implementation of the second aspect, determining the point set composed of K nearest neighbor points of the current point comprises: determining the point set composed of K nearest neighbor points of the current point according to a spatial distance from points in the point cloud to the current point.

In conjunction with the second aspect, in a second possible implementation of the second aspect, determining the point set composed of L next nearest neighbor points of the current point comprises: determining the point set composed of L next nearest neighbor points of the current point according to the spatial distance from the points in the point cloud to the current point.

In conjunction with the second aspect and the first to the second possible implementations of the second aspect, in a third possible implementation of the second aspect, determining the preferred neighbor point set of the current point according to the point set composed of K nearest neighbor points of the current point and the point set composed of L next nearest neighbor points of the current point comprises: determining a distance from a center of the point set composed of K nearest neighbor points of the current point to the current point as a first distance; determining a distance from a center of a point set composed of a total of K-H+I points (i.e. K-H nearest neighbor points in the point set composed of K nearest neighbor points of the current point and I next nearest neighbor points in the point set composed of L next nearest neighbor points of the current point) to the current point as a second distance; determining the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when a difference between the first distance and the second distance is greater than a set value, or determining the point set composed of K nearest neighbor points of the current point as the preferred neighbor point set of the current point when the difference between the first distance and the second distance is less than or equal to the set value.

In conjunction with the second aspect and the first to the second possible implementations of the second aspect, in a fourth possible implementation of the second aspect, determining the preferred neighbor point set of the current point according to the point set composed of K nearest neighbor points of the current point and the point set composed of L next nearest neighbor points of the current point comprises: determining the distance from the center of the point set composed of the K nearest neighbor points of the current point to the current point as the first distance; determining the distance from the center of the point set composed of a total of K-H+I points (i.e. K-H nearest neighbor points in the point set composed of K nearest neighbor points of the current point and I next nearest neighbor points in the point set composed of L next nearest neighbor points of the current point) to the current point as the second distance; and determining the point set composed of K nearest neighbor points of the current point as the preferred neighbor point set of the current point when the difference between the first distance and the second distance is less than or equal to the set value, or, determining the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when the difference between the first distance and the second distance is greater than the set value and the replacement flag is a valid replacement flag, or determining the point set composed of K nearest neighbor points of the current point as the preferred neighbor point set of the current point when the difference between the first distance and the second distance is greater than the set value and the replacement flag is an invalid replacement flag.

In conjunction with the third possible implementation of the second aspect, in a fifth possible implementation of the second aspect, performing decoding according to the preferred neighbor point set of the current point comprises: determining a predicted value of the current point according to the preferred prediction mode and the preferred neighbor point set; and determining an attribute value of the current point according to a sum of the predicted value of the current point and the predicted residual of the current point.

In conjunction with the fourth possible implementation of the second aspect, in a sixth possible implementation of the second aspect, performing decoding according to the preferred neighbor point set of the current point comprises: determining the predicted value of the current point according to the preferred prediction mode and the preferred neighbor point set; and determining the attribute value of the current point according to the sum of the predicted value of the current point and the predicted residual of the current point.

In a third aspect, provided by the present invention is a point cloud encoding device, which comprises: a first determination module used to determine a point set composed of K nearest neighbor points of a current point; a second determination module used to determine a point set composed of L next nearest neighbor points of the current point; a third determination module used to determine a preferred nearest neighbor point set of the current point according to the point set composed of K nearest neighbor points of the current point and the point set composed of L next nearest neighbor points of the current point; and an encoding module used to perform encoding according to the preferred nearest neighbor point set of the current point.

In conjunction with the third aspect, in a first possible implementation of the third aspect, the first determination module is specifically used to determine the point set composed of K nearest neighbor points according to a spatial distance from points in the point cloud to the current point.

In conjunction with the third aspect, in a second possible implementation of the third aspect, the second determination module is specifically used to determine the point set composed of L next nearest neighbor points of the current point according to the spatial distance from the points in the point cloud to the current point.

In conjunction with the third aspect and the first to the second possible implementations of the third aspect, in a third possible implementation of the third aspect, the third determination module is specifically used to: determine a distance from a center of the point set composed of K nearest neighbor points of the current point to the current point as a first distance; determine a distance from a center of a point set composed of a total of K-H+I points (i.e. K-H nearest neighbor points in the point set composed of K nearest neighbor points of the current point and I next nearest neighbor points in the point set composed of L next nearest neighbor points of the current point) to the current point as a second distance; and determine the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when a difference between the first distance and the second distance is greater than a set value, or determine the point set composed of K nearest neighbor points of the current point as the preferred neighbor point set of the current point when the difference between the first distance and the second distance is less than or equal to the set value.

In conjunction with the third aspect and the first to the second possible implementations of the third aspect, in a fourth possible implementation of the third aspect, the third determination module is specifically used to: determine the distance from the center of the point set composed of K nearest neighbor points of the current point to the current point as the first distance; determine the distance from the center of the point set composed of a total of K-H+I points (i.e. K-H nearest neighbor points in the point set composed of K nearest neighbor points of the current point and I next nearest neighbor points in the point set composed of L next nearest neighbor points of the current point) to the current point as the second distance; determine the point set composed of K nearest neighbor points of the current point as the preferred neighbor point set of the current point when the difference between the first distance and the second distance is less than or equal to the set value, or when the difference between the first distance and the second distance is greater than the set value: determine a minimum cost value of the point set composed of K nearest neighbor points of the current point as a first cost value; determine a minimum cost value of the point set composed of a total of K-H+I points (i.e. K-H nearest neighbor points in the point set composed of K nearest neighbor points of the current point and I next nearest neighbor points in the point set composed of L next nearest neighbor points of the current point) as a second cost value; and determine the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when the second cost value is less than the first cost value, or determine the point set composed of K nearest neighbor points of the current point as the preferred neighbor point set of the current point when the second cost value is greater than or equal to the first cost value.

In conjunction with the third possible implementation of the third aspect, in a fifth possible implementation of the third aspect, the encoding module is specifically used to: determine a weighted mean of reconstructed attribute values of all points in the preferred neighbor point set of the current point as a candidate predicted value 1, and determine the corresponding mode as a prediction mode 1; sequentially determine the reconstructed attribute values of all points in the preferred neighbor point set of the current point as candidate predicted value 2 to candidate predicted value N+1, and determine the corresponding modes as the prediction mode 2 to prediction mode N+1, wherein N is the number of points in the point set; calculate a cost value Jn of the prediction mode 1 to the prediction mode N+1, wherein n is from 1 to N+1, determine the minimum value in Jn as the minimum cost value, and determine the corresponding mode of the minimum cost value as an preferred prediction mode; determine the predicted value of the current point according to the preferred prediction mode; determine a predicted residual of the current point according to a difference between the attribute value of the current point and the predicted value of the current point; and encode the preferred prediction mode and the predicted residual.

In conjunction with the fourth possible implementation of the third aspect, in a sixth possible implementation of the third aspect, the encoding module is specifically used to: determine the weighted mean of the reconstructed attribute values of all points in the preferred neighbor point set of the current point as the candidate predicted value 1, and determine the corresponding mode as a prediction mode 1; sequentially determine the reconstructed attribute values of all points in the preferred neighbor point set of the current point as the candidate predicted value 2 to candidate predicted value N+1, and sequentially determine the corresponding mode as the prediction mode 2 to prediction mode N+1, wherein N is the number of points in the point set; calculate the cost value Jn of the prediction mode 1 to the prediction mode N+1, wherein n is from 1 to N+1, determine the minimum value in Jn as the minimum cost value, and determine the corresponding mode of the minimum cost value as the preferred prediction mode; determine the predicted value of the current point according to the preferred prediction mode; determine the predicted residual of the current point according to the difference between the attribute value of the current point and the predicted value of the current point; and encode the preferred prediction mode and the predicted residual when the difference between the first distance and the second distance is less than or equal to the set value, or encode a valid replacement flag, the preferred prediction mode and the predicted residual when the difference between the first distance and the second distance is greater than the set value, and the second cost value is less than the first cost value, or encode an invalid replacement flag, the preferred prediction mode and the predicted residual when the difference between the first distance and the second distance is greater than the set value and the second cost value is greater than or equal to the first cost value.

In a fourth aspect, provided by the present invention is a point cloud decoding device, which comprises: a first determination module used to determine a point set composed of K nearest neighbor points of a current point; a second determination module used to determine a point set composed of L next nearest neighbor points of the current point; a third determination module used to determine a preferred nearest neighbor point set of the current point according to the point set composed of K nearest neighbor points of the current point and the point set composed of L next nearest neighbor points of the current point; and a decoding module used to perform decoding according to the preferred nearest neighbor point set of the current point.

In conjunction with the fourth aspect, in a first possible implementation of the fourth aspect, the first determination module is specifically used to determine the point set composed of K nearest neighbor points according to a spatial distance from points in the point cloud to the current point.

In conjunction with the fourth aspect, in a second possible implementation of the fourth aspect, the second determination module is specifically used to determine the point set composed of L next nearest neighbor points of the current point according to the spatial distance from the points in the point cloud to the current point.

In conjunction with the fourth aspect and the first to the second possible implementations of the fourth aspect, in a third possible implementation of the fourth aspect, the third determination module is specifically used to: determine a distance from a center of the point set composed of K nearest neighbor points of the current point to the current point as a first distance; determine a distance from a center of a point set composed of a total of K-H+I points (i.e. K-H nearest neighbor points in the point set composed of K nearest neighbor points of the current point and I next nearest neighbor points in the point set composed of L next nearest neighbor points of the current point) to the current point as a second distance; and determine the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when a difference between the first distance and the second distance is greater than a set value, or determine the point set composed of K nearest neighbor points of the current point as the preferred neighbor point set of the current point when the difference between the first distance and the second distance is less than or equal to the set value.

In conjunction with the fourth aspect and the first to the second possible implementations of the fourth aspect, in a fourth possible implementation of the fourth aspect, the third determination module is specifically used to: determine the distance from the center of the point set composed of the K nearest neighbor points of the current point to the current point as the first distance; determine the distance from the center of the point set composed of a total of K-H+I points (i.e. K-H nearest neighbor points in the point set composed of K nearest neighbor points of the current point and I next nearest neighbor points in the point set composed of L next nearest neighbor points of the current point) to the current point as the second distance; and determine the point set composed of K nearest neighbor points of the current point as the preferred neighbor point set of the current point when the difference between the first distance and the second distance is less than or equal to the set value, or determine the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when the difference between the first distance and the second distance is greater than the set value and the replacement flag is a valid replacement flag, or determine the point set composed of K nearest neighbor points of the current point as the preferred neighbor point set of the current point when the difference between the first distance and the second distance is greater than the set value and the replacement flag is an invalid replacement flag.

In conjunction with any possible implementation of the third possible implementation of the fourth aspect, in a fifth possible implementation of the fourth aspect, the decoding module is specifically used to: determine a predicted value of the current point according to the preferred prediction mode and the preferred neighbor point set; and determine an attribute value of the current point according to a sum of the predicted value of the current point and the predicted residual of the current point.

In conjunction with any possible implementation of the fourth possible implementation of the fourth aspect, in a sixth possible implementation of the fourth aspect, the decoding module is specifically used to: determine the predicted value of the current point according to the preferred prediction mode and the preferred neighbor point set; and determine the attribute value of the current point according to a sum of the predicted value of the current point and the predicted residual of the current point.

According to the above technical solutions, the point cloud encoding and decoding methods, the encoding device and the decoding device of embodiments of the present invention determine the preferred neighbor point set of the current point according to the point set composed of K nearest neighbor points of the current point and the point set composed of L next nearest neighbor points of the current point. Therefore, the point cloud encoding and decoding performance may be improved by means of selecting the neighbor point set having the appropriate distribution in the point cloud encoding and decoding process.

### BRIEF DESCRIPTION OF THE DRAWINGS

To more clearly describe the technical solutions in the embodiments of the present invention, the drawings required to be used in the description of the embodiments or in the prior art will be simply presented below. Apparently, the following drawings show some embodiments of the present invention, so for those ordinary skilled in the art, other drawings can also be obtained according to these drawings without contributing creative labor.

FIG. 1 is a schematic flow diagram of a point cloud encoding method according to embodiments of the present invention;

FIG. 2 is another schematic flow diagram of the point cloud encoding method according to embodiments of the present invention;

FIG. 3 is a schematic diagram of a preferred neighbor point set according to embodiments of the present invention;

FIG. 4 is further another schematic flow diagram of the point cloud encoding method according to embodiments of the present invention;

FIG. 5 is further another schematic flow diagram of the point cloud encoding method according to embodiments of the present invention;

FIG. 6 is further another schematic flow diagram of the point cloud encoding method according to embodiments of the present invention;

FIG. 7 is a schematic flow diagram of a point cloud decoding method according to embodiments of the present invention;

FIG. 8 is another schematic flow diagram of the point cloud decoding method according to embodiments of the present invention;

FIG. 9 is further another schematic flow diagram of the point cloud decoding method according to embodiments of the present invention;

FIG. 10 is further another schematic flow diagram of the point cloud decoding method according to embodiments of the present invention;

FIG. 11 is a schematic block diagram of an encoding device according to embodiments of the present invention; and

FIG. 12 is a schematic block diagram of a decoding device according to embodiments of the present invention.

### DETAILED DESCRIPTION OF THE INVENTION

Technical solutions in embodiments of the present invention are clearly and completely described in conjunction with accompanying drawings in embodiments of the present invention. Apparently, the described embodiments are some embodiments of the present invention, not all embodiments. Based on the embodiments of the present invention, all other embodiments obtained by those skilled in the art without creative effort fall within the protection scope of the present invention.

FIG. 1 shows a schematic flow diagram of a point cloud encoding method according to embodiments of the present invention. The method shown in FIG. 1 is performed by an encoding device such as an encoder. Specifically as shown in FIG. 1, the method 1000 includes:

S1100, a point set composed of K nearest neighbor points of a current point is determined;

S1200, a point set composed of L next nearest neighbor points of the current point is determined;

S1300, a preferred neighbor point set of the current point is determined according to the point set composed of K nearest neighbor points of the current point and the point set composed of L next nearest neighbor points of the current point; and

S1400, encoding is performed according to the preferred neighbor point set of the current point.

Specifically, the encoding device determines the point set composed of K nearest neighbor points of the current point and the point set composed of L next nearest neighbor points of the current point according to a spatial distance from points in the point cloud to the current point, determines the preferred neighbor point set of the current point according to the determined point set composed of K nearest neighbor points of the current point and the point set composed of L next nearest neighbor points of the current point, and performs the encoding according to the determined preferred neighbor point set.

Therefore, in the point cloud encoding method of embodiments of the present invention, the encoding device determines the preferred neighbor point set of the current point through the determined point set composed of K nearest neighbor points of the current point and the point set composed of L next nearest neighbor points of the current point and performs the encoding according to the preferred neighbor point set. Therefore, the encoding performance may be improved by means of selecting the preferred neighbor point set having an appropriate distribution in the encoding process.

Preferably, in S1100, the point set composed of K nearest neighbor points of the current point is determined according to the spatial distance from the points in the point cloud to the current point.

It should be understood that in the embodiments of the present invention, the points in the point cloud are the points that are already encoded before the encoding of the current point.

It should also be understood that in the embodiments of the present invention, the spatial distance may be the Euclidean distance, the Cosine distance or distances calculated in other methods, which are not limited here.

It should also be understood that in the embodiments of the present invention, K is a natural number.

It should also be understood that in the embodiments of the present invention, the point set composed of K nearest neighbor points of the current point is a point set composed of K points in the point cloud having a shortest distance to the current point.

Preferably, in S1200, the point set composed of L next nearest neighbor points of the current point is determined according to the spatial distance from the points in the point cloud to the current point.

It should be understood that in the embodiments of the present invention, the points in the point cloud are the points that are already encoded before the encoding of the current point.

It should also be understood that in the embodiments of the present invention, the spatial distance may be the Euclidean distance, the Cosine distance or distances calculated in other methods, which are not limited herein.

It should also be understood that in the embodiments of the present invention, L is a positive integer.

It should also be understood that in the embodiments of the present invention, L may be equal to K and may not be equal to K, which is not limited here.

It should also be understood that in the embodiments of the present invention, the point set composed of L next nearest neighbor points of the current point is a point set composed of L points in the point cloud having a shortest distance to the current point except for the K nearest neighbor points.

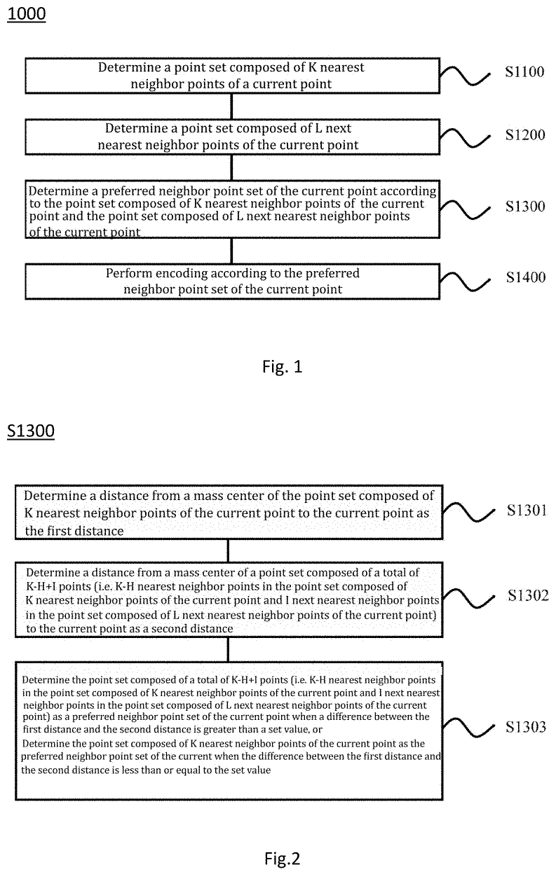

Preferably, as shown in FIG. 2, S1300 includes

S1301, a distance from a center of the point set composed of K nearest neighbor points of the current point to the current point is determined as a first distance;

S1302, a distance from a center of a point set composed of a total of K-H+I points (i.e. K-H nearest neighbor points in the point set composed of K nearest neighbor points of the current point and I next nearest neighbor points in the point set composed of L next nearest neighbor points of the current point) to the current point is determined as a second distance;

S1303, when a difference between the first distance and the second distance is greater than a set value, the point set composed of a total of K-H+I points (i.e. K-H nearest neighbor points in the point set composed of K nearest neighbor points of the current point and I next nearest neighbor points in the point set composed of L next nearest neighbor points of the current point) is determined as a preferred neighbor point set of the current point, or

When the difference between the first distance and the second distance is less than or equal to the set value, the point set composed of K nearest neighbor points of the current point is determined as the preferred neighbor point set of the current point.

It should be understood that in the embodiments of the present invention H is a natural number and is less than or equal to K.

It should also be understood that in the embodiments of the present invention I is a positive integer and is less than or equal to L.

It should also be understood that in the embodiments of the present invention, I may be equal to H and may not be equal to H, which is not limited here.

It should also be understood that in the embodiments of the present invention, the K-H nearest neighbor points are K-H points in the point set composed of K nearest neighbor points of the current point having the shortest distance to the current point.

It should also be understood that in the embodiments of the present invention, I next nearest neighbor points are I points in the point set composed of L next nearest neighbor points of the current point having the shortest distance to the current point.

It should also be understood that in the embodiments of the present invention the set value may be a constant, such as 0, or other values, and may not be a constant, such as a function of the first distance and/or the second distance, for example, the first distance multiplied by a constant, which is not limited here.

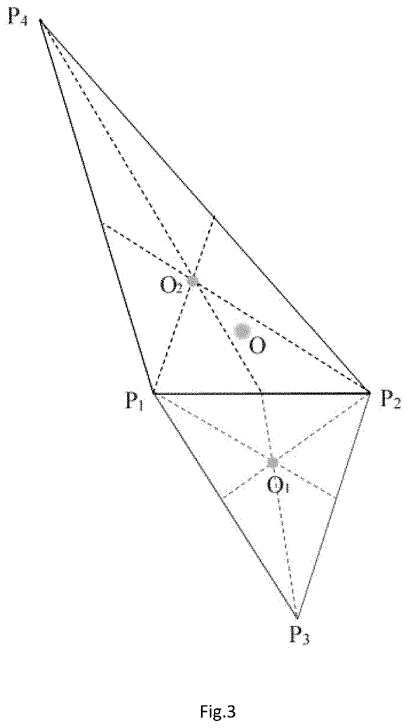

For example, FIG. 3 is a schematic diagram of the preferred neighbor point set according to the embodiments of the present invention. The points P1, P2 and P3 in the three-dimensional space constitute the nearest neighbor point set of the current point O, and K is 3; the point 4 in the three-dimensional space constitutes the next nearest neighbor point set of the current point O, and L is 1; the point O1 is the center of the nearest neighbor point set composed of the points P1, P2 and P3; the point O2 is the center of the point set composed of the points P1, P2 and P4, H is 1, and I is 1; and when the difference between the Euclidean distance from the point O1 to the point O and the Euclidean distance from the point O2 to the point O is greater than 0, the point set composed of the points P1, P2 and P4 is determined as the preferred neighbor point set of the current point O, and when the difference between the Euclidean distance from the point O1 to the point O and the Euclidean distance from the point O2 to the point O is less than or equal to 0, the point set composed of the points P1, P2 and P3 is determined as the preferred neighbor point set of the current point O, wherein the set value is 0.

Therefore, in the point cloud encoding method of embodiments of the present invention, the encoding device determines the preferred neighbor point set of the current point through the determined point set composed of K nearest neighbor points of the current point and the point set composed of L next nearest neighbor points and performs the encoding according to the preferred neighbor point set of the current point. Therefore, the encoding performance may be improved by means of selecting the preferred neighbor point set having an appropriate distribution in the encoding process.

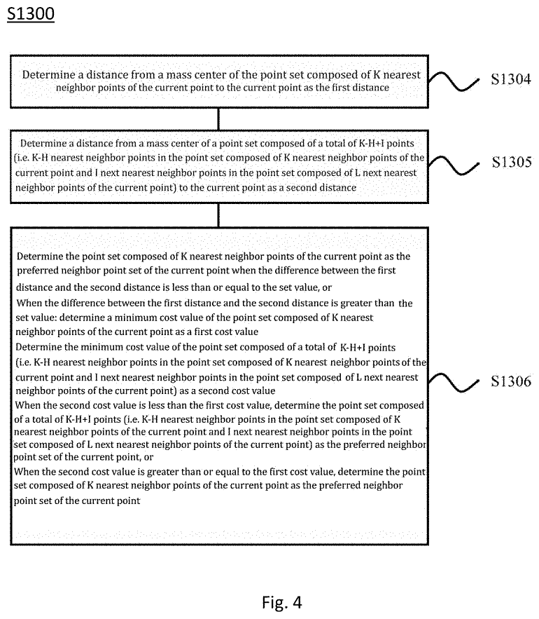

Optionally, as shown in FIG. 4, S1300 includes:

S1304, the distance from the center of the point set composed of K nearest neighbor points of the current point to the current point is determined as the first distance;

S1305, the distance from a center of the point set composed of a total of K-H+I points (i.e. K-H nearest neighbor points in the point set composed of K nearest neighbor points of the current point and I next nearest neighbor points in the point set composed of L next nearest neighbor points of the current point) to the current point is determined as the second distance;

S1306, when the difference between the first distance and the second distance is less than or equal to the set value, the point set composed of K nearest neighbor points of the current point is determined as the preferred neighbor point set of the current point, or

When the difference between the first distance and the second distance is greater than the set value:

A minimum cost value of the point set composed of K nearest neighbor points of the current point is determined as a first cost value;

The minimum cost value of the point set composed of a total of K-H+I points (i.e. K-H nearest neighbor points in the point set composed of K nearest neighbor points of the current point and I next nearest neighbor points in the point set composed of L next nearest neighbor points of the current point) is determined as a second cost value;

When the second cost value is less than the first cost value, the point set composed of a total of K-H+I points (i.e. K-H nearest neighbor points in the point set composed of K nearest neighbor points of the current point and I next nearest neighbor points in the point set composed of L next nearest neighbor points of the current point) is determined as the preferred neighbor point set of the current point, or

When the second cost value is greater than or equal to the first cost value, the point set composed of K nearest neighbor points of the current point is determined as the preferred neighbor point set of the current point.

Specifically, when the difference between the first distance and the second distance is greater than the set value, the preferred neighbor point set is determined further by the minimum cost value.

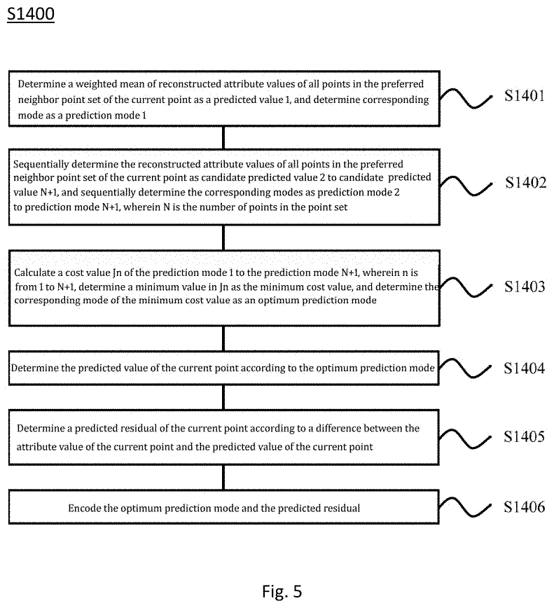

Preferably, as shown in FIG. 5, S1400 includes:

S1401, a weighted mean of reconstructed attribute values of all points in the preferred neighbor point set of the current point is determined as a candidate predicted value 1, and a corresponding mode is determined as a prediction mode 1;

S1402, the reconstructed attribute values of all points in the preferred neighbor point set of the current point are sequentially determined as candidate predicted value 2 to candidate predicted value N+1, and the corresponding modes are sequentially determined as prediction mode 2 to prediction mode N+1, wherein N is the number of points in the point set;

S1403, a cost value Jn of the prediction mode 1 to the prediction mode N+1 is calculated, n is from 1 to N+1, a minimum value in Jn is determined as the minimum cost value, and the corresponding mode of the minimum cost value is determined as an preferred prediction mode;

S1404, the predicted value of the current point is determined according to the preferred prediction mode;

S1405, a predicted residual of the current point is determined according to a difference between an attribute value of the current value and the predicted value of the current point; and

S1406, the preferred prediction mode and the predicted residual are encoded.

It should be understood that in the embodiments of the present invention, the reconstructed attribute value is a reconstructed attribute value that is encoded, and the reconstructed attribute may be a color attribute and may also be reflectivity or other attributes, which is not limited here.

It should also be understood that in the embodiments of the present invention a weight in the weighted mean may be a weight of a function of the distance from each point in the point set to the current point, such as a reciprocal of the distance that is the weight, and may also be other variables or constants, which is not limited here.

It should also be understood that in the embodiments of the present invention the encoding method for the preferred prediction mode and the predicted residual may be arithmetic encoding and may also be Huffman encoding or other entropy encoding algorithms, which is not limited here.

It should also be understood that in the embodiments of the present invention a calculation method of the cost value is:

score=attrResidualQuant+idxBits*kAttrPredLambdaR*qs

Score is a total cost value; attrResidualQuant is an absolute value of the difference between the attribute value and the predicted value of the current point under the prediction mode through transformation and quantification; and idxBits*kAttrPredLambdaR*qs is a cost of encoding an prediction mode index, wherein idxBits is the prediction mode index, kAttrPredLambdaR is a preset constant, and qs is an attribute quantization step. The cost value may also be calculated by other calculation methods, which is not limited here.

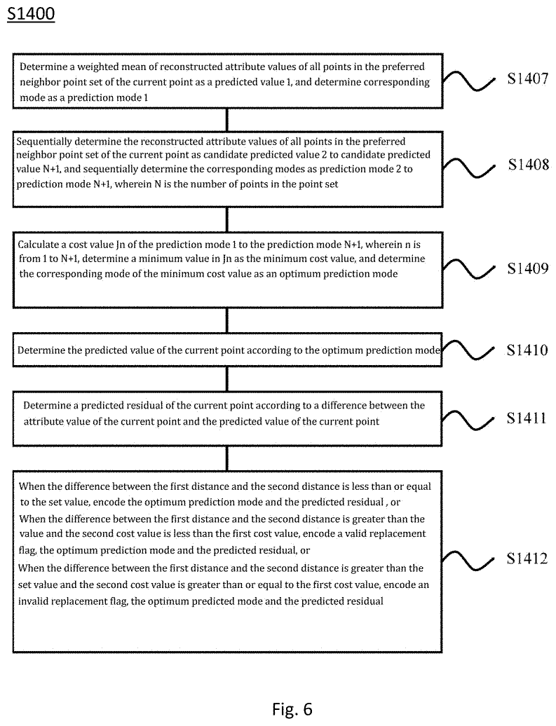

Optionally, as shown in FIG. 6, S1400 includes:

S1407, a weighted mean of reconstructed attribute values of all points in the preferred neighbor point set of the current point is determined as a candidate predicted value 1, and a corresponding mode is determined as a prediction mode 1;

S1408, the reconstructed attribute values of all points in the preferred neighbor point set of the current point are sequentially determined as candidate predicted value 2 to candidate predicted value N+1, and the corresponding modes are sequentially determined as prediction mode 2 to prediction mode N+1, wherein N is the number of points in the point set;

S1409, a cost value Jn of the prediction mode 1 to the prediction mode N+1 is calculated, n is from 1 to N+1, a minimum value in Jn is determined as the minimum cost value, and the corresponding mode of the minimum cost value is determined as an preferred prediction mode;

S1410, the predicted value of the current point is determined according to the preferred prediction mode;

S1411, the predicted residual of the current point is determined according to the difference between the attribute value of the current point and the predicted value of the current point; and

S1412, when the difference between the first distance and the second distance is less than or equal to the set value, the preferred prediction mode and the predicted residual are encoded, or,

when the difference between the first distance and the second distance is greater than the set value and the second cost value is less than the first cost value, a valid replacement flag, the preferred prediction mode and the predicted residual are encoded, or
when the difference between the first distance and the second distance is greater than the set value and the second cost value is greater than or equal to the first cost value, an invalid replacement flag, the preferred prediction mode and the predicted residual are encoded. In order to better prove the beneficial effects of the embodiments of the present invention relative to the prior art, table 1 shows performance comparative results of the point cloud encoding method in the embodiments of the present invention and the point cloud encoding method in TMC13 v5.

TABLE 1

| | | | Method of the present invention |
|---|---|---|---|
| Test condition | Attribute | | VS method in the prior art |
| C1 | Color | Luma | −0.7% |
| (No geometric damage, | | Cb | −1.1% |
| Attribute damage) | | Cr | −1.2% |
| | Reflectivity | | −0.9% |
| C2 | Color | Luma | −1.0% |
| (No geometric damage, | | Cb | −1.6% |
| No attribute damage) | | Cr | −1.3% |

| | |
|---|---|
| Reflectivity | −1.0% |

It can be seen from table 1 that by using the point cloud encoding method in the embodiments of the present invention, the encoding performance can be improved.

Therefore, in the point cloud encoding method of embodiments of the present invention, the encoding device determines the preferred neighbor point set of the current point through the determined point set composed of K nearest neighbor points of the current point and the point set composed of L next nearest neighbor points of the current point and performs the encoding according to the preferred neighbor point set. Therefore, the encoding performance may be improved by means of selecting the preferred neighbor point set having an appropriate distribution in the encoding process.

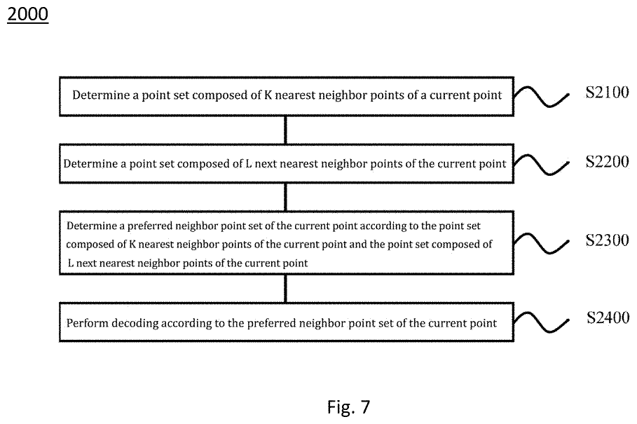

The point cloud encoding method according to the embodiments of the present invention is described above in detail in conjunction with FIG. 1 to FIG. 6. A point cloud decoding method according to the embodiments of the present invention is described below in detail in conjunction with FIG. 7 to FIG. 10. It should be noted that relevant operations of the decoding end are essentially the same with those of the encoding end, and in order to avoid repetition, details are not repeated here.

FIG. 7 shows a schematic flow diagram of a point cloud decoding method according to the embodiments of the present invention. The method shown in FIG. 7 is performed by a decoding device such as a decoder. Specifically as shown in FIG. 7, the method 2000 includes:

S2100, a point set composed of K nearest neighbor points of a current point is determined;

S2200, a point set composed of L next nearest neighbor points of the current point is determined;

S2300, a preferred neighbor point set of the current point is determined according to the point set composed of K nearest neighbor points of the current point and the point set composed of L next nearest neighbor points of the current point; and

S2400, decoding is performed according to the preferred neighbor point set of the current point.

Specifically, the decoding device determines the point set composed of K nearest neighbor points of the current point and the point set composed of L next nearest neighbor points of the current point according to a spatial distance from points in the point cloud to the current point, determines the preferred neighbor point set of the current point according to the determined point set composed of K nearest neighbor points of the current point and the point set composed of L next nearest neighbor points of the current point, and performs the decoding according to the determined preferred neighbor point set.

Therefore, in the point cloud decoding method of the embodiments of the present invention, the decoding device determines the preferred neighbor point set of the current point through the determined point set composed of K nearest neighbor points of the current point and the point set composed of L next nearest neighbor points of the current point and performs the decoding according to the preferred neighbor point set. Therefore, the decoding performance may be improved by means of selecting the preferred neighbor point set having an appropriate distribution in the decoding process.

Preferably, in S2100, the point set composed of K nearest neighbor points of the current point is determined according to the spatial distance from the points that are already decoded in the point cloud to the current point.

It should also be understood that in the embodiments of the present invention, the spatial distance may be the Euclidean distance or distances calculated in other methods, which are not limited here.

It should also be understood that in the embodiments of the present invention, K is a natural number.

It should also be understood that in the embodiments of the present invention, the point set composed of K nearest neighbor points of the current point is a point set composed of K points in the point cloud having a shortest distance to the current point.

Preferably, in S2200, the point set composed of L next nearest neighbor points of the current point is determined according to the spatial distance from the points that are already decoded in the point cloud to the current point.

It should also be understood that in the embodiments of the present invention, the spatial distance may be the Euclidean distance or distances calculated in other methods, which are not limited here.

It should also be understood that in the embodiments of the present invention, L is a positive integer.

It should also be understood that in the embodiments of the present invention, L may be equal to K and may not be equal to K, which is not limited here.

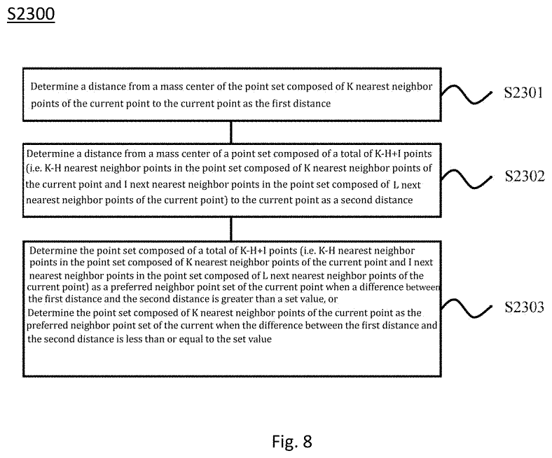

It should be also understood that in the embodiments of the present invention, the point set composed of L next nearest neighbor points of the current point is a point set composed of L points in the point cloud having a shortest distance to the current point except for the K nearest neighbor points. Preferably, as shown in FIG. 8, S2300 includes

S2301, the distance from a center of the point set composed of K nearest neighbor points of the current point to the current point is determined as a first distance;

S2302, the distance from a center of a point set composed of a total of K-H+I points (i.e. K-H nearest neighbor points in the point set composed of K nearest neighbor points of the current point and I next nearest neighbor points in the point set composed of L next nearest neighbor points of the current point) to the current point is determined as a second distance;

S2303, when a difference between the first distance and the second distance is greater than a set value, the point set composed of a total of K-H+I points (i.e. K-H nearest neighbor points in the point set composed of K nearest neighbor points of the current point and I next nearest neighbor points in the point set composed of L next nearest neighbor points of the current point) is determined as a preferred neighbor point set of the current point, or

When the difference between the first distance and the second distance is less than or equal to the set value, the point set composed of K nearest neighbor points of the current point is determined as the preferred neighbor point set of the current point.

It should be understood that in the embodiments of the present invention H is a natural number and is less than or equal to K.

It should also be understood that in the embodiments of the present invention I is a positive integer and is less than or equal to L.

It should also be understood that in the embodiments of the present invention, I may be equal to H and may not be equal to H, which is not limited here.

It should be also understood that in the embodiments of the present invention, the K-H nearest neighbor points are K-H points in the point set composed of K nearest neighbor points of the current point having the shortest distance to the current point.

It should be also understood that in the embodiments of the present invention, I next nearest neighbor points are I points in the point set composed of L next nearest neighbor points of the current point having the shortest distance to the current point.

It should also be understood that in the embodiments of the present invention the set value may be a constant, such as 0, or other values, and may not be a constant, such as a function of the first distance and/or the second distance, for example, the first distance multiplied by a constant, which is not limited here.

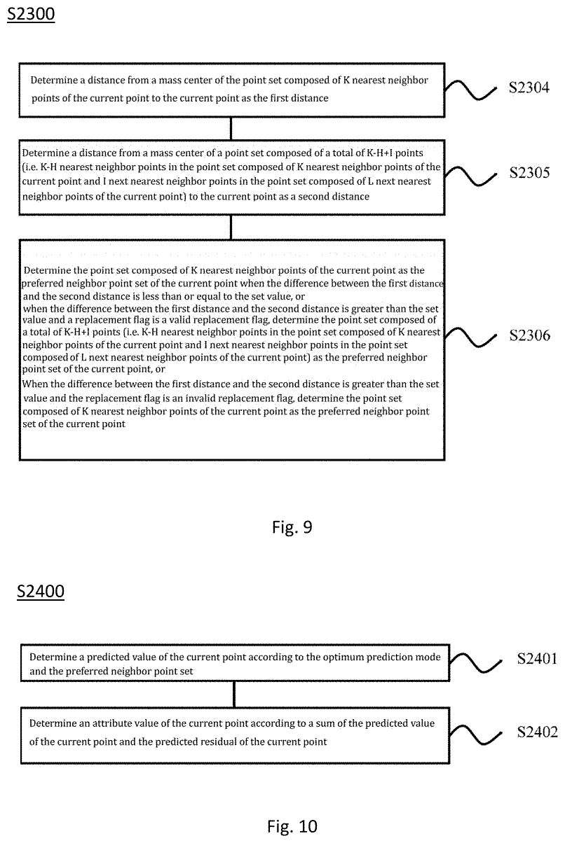

Optionally, as shown in FIG. 9, S2300 includes:

S2304, the distance from the center of the point set composed of K nearest neighbor points of the current point to the current point is determined as the first distance;

S2305, the distance from the center of the point set composed of a total of K-H+I points (i.e. K-H nearest neighbor points in the point set composed of K nearest neighbor points of the current point and I next nearest neighbor points in the point set composed of L next nearest neighbor points of the current point) to the current point is determined as the second distance;

S2306, when the difference between the first distance and the second distance is less than or equal to the set value, the point set composed of K nearest neighbor points of the current point is determined as the preferred neighbor point set of the current point, or

when the difference between the first distance and the second distance is greater than the set value and a replacement flag is a valid replacement flag, the point set composed of a total of K-H+I points (i.e. K-H nearest neighbor points in the point set composed of K nearest neighbor points of the current point and I next nearest neighbor points in the point set composed of L next nearest neighbor points of the current point) is determined as the preferred neighbor point set of the current point, or

When the difference between the first distance and the second distance is greater than the set value and the replacement flag is an invalid replacement flag, the point set composed of K nearest neighbor points of the current point is determined as the preferred neighbor point set of the current point.

It should be understood that the replacement flag is used to identify the valid replacement flag and the invalid replacement flag, which can be one bit of the binary bit, wherein 1 indicates the valid replacement flag and 0 indicates the invalid replacement flag, or conversely, 0 indicates the valid replacement flag, and 1 indicates the invalid replacement flag. It is not limited here.

Preferably, as shown in FIG. 10, S2400 includes

S2401, the predicted value of the current point is determined according to the preferred prediction mode and the preferred neighbor point set;

S2402, the attribute value of the current point is determined according to a sum of the predicted value of the current point and the predicted residual of the current point.

Preferably, there are N+1 modes for one point set, which are the weighted mean mode of the reconstructed attribute values of all points in the point set and the reconstructed attribute value modes of all points in the point set, wherein N is the number of points in the point set. The mode is determined according to the preferred prediction mode so as to determine the predicted value of the current point.

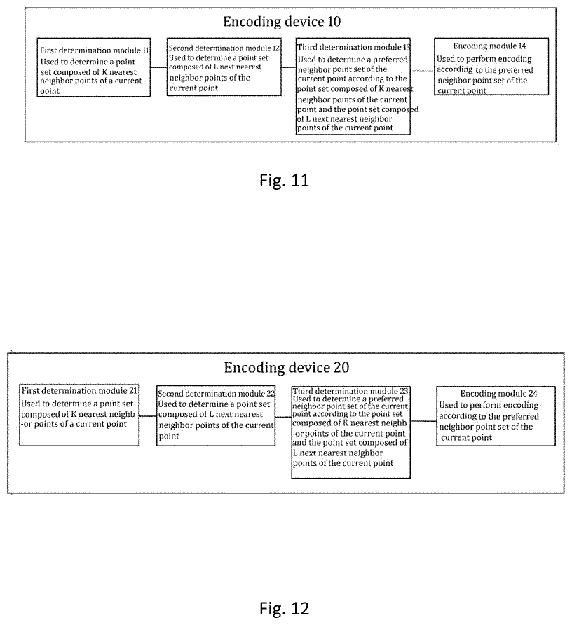

An encoding device of the embodiments of the present invention is described below in detail in conjunction with FIG. 11. As shown in FIG. 11, the encoding device 10 includes:

A first determination module 11 used to determine a point set composed of K nearest neighbor points of a current point;

A second determination module 12 used to determine a point set composed of L next nearest neighbor points of the current point;

A third determination module 13 used to determine a preferred neighbor point set of the current point according to the point set composed of K nearest neighbor points of the current point and the point set composed of L next nearest neighbor points of the current point; and

An encoding module 14 used to perform encoding according to the preferred neighbor point set of the current point.

Specifically, the encoding device determines the point set composed of K nearest neighbor points of the current point and the point set composed of L next nearest neighbor points of the current point according to a spatial distance from points in the point cloud to the current point, determines the preferred neighbor point set of the current point according to the determined point set composed of K nearest neighbor points of the current point and the point set composed of L next nearest neighbor points of the current point, and performs the encoding according to the determined preferred neighbor point set.

Therefore, the encoding device of the embodiments of the present invention determines the preferred neighbor point set of the current point through the determined point set composed of K nearest neighbor points of the current point and the point set composed of L next nearest neighbor points of the current point and performs the encoding according to the preferred neighbor point set. Therefore, the encoding performance may be improved by means of selecting the preferred neighbor point set having an appropriate distribution for encoding in the encoding process.

A decoding device of the embodiments of the present invention is described below in detail in conjunction with FIG. 12. As shown in FIG. 12, the decoding device 20 includes:

A first determination module 21 used to determine a point set composed of K nearest neighbor points of a current point;

A second determination module 22 used to determine a point set composed of L next nearest neighbor points of the current point;

A third determination module 23 used to determine a preferred neighbor point set of the current point according to the point set composed of K nearest neighbor points of the current point and the point set composed of L next nearest neighbor points of the current point; and

A decoding module 24 used to perform decoding according to the preferred neighbor point set of the current point.

Specifically, the decoding device determines the point set composed of K nearest neighbor points of the current point and the point set composed of L next nearest neighbor points of the current point according to a spatial distance from points in the point cloud to the current point, determines the preferred neighbor point set of the current point according to the determined point set composed of K nearest neighbor points of the current point and the point set composed of L next nearest neighbor points of the current point, and performs the decoding according to the determined preferred neighbor point set.

Therefore, the decoding device of the embodiments of the present invention determines the preferred neighbor point set of the current point through the determined point set composed of K nearest neighbor points of the current point and the point set composed of L next nearest neighbor points of the current point and performs the decoding according to the preferred neighbor point set. Therefore, the decoding performance may be improved by means of selecting the preferred neighbor point set having an appropriate distribution for decoding in the decoding process.

It should be understood that, in various embodiments of the present invention, the sequence numbers of the above processes do not mean the order of execution. The execution order of the processes should be determined by their functions and internal logic rather than constituting any limitation to the implementation process of the embodiments of the present invention.

It should be understood that the term “and/or” used here is only an association relationship describing the associated objects, which means that there can be three relationships, for example, A and/or B can mean that there is only A, there are A and B, and there is only B. In addition, the character “/” used here generally indicates that the associated objects are in an “or” relationship.

In the embodiments provided by the present invention, it should be understood that “B corresponding to A” means that B is associated with A, and B may be determined according to A. However, it should also be understood that “B is determined according to A” does not mean that the B is determined only according to A and may also be determined according to A and/or other information.

The ordinary skilled in the art can realize that units and algorithm steps of various examples described in the embodiments disclosed here can be implemented by electronic hardware, computer hardware or a combination of the two. In order to clearly illustrate the interchangeability of the hardware and the software, the composition and steps of each example are already described generally in accordance with functions in the above description. Whether these functions are executed with hardware or software depend on the specific application and designed constraint conditions of the technical solution. Professional technicians can use different methods to implement the described functions for each specific application, but such implementation should not be considered beyond the scope of the present disclosure.

Those skilled in the art may clearly learn about that for the convenience and brevity of description, the specific working process of the above systems, apparatuses and units may refer to the corresponding processes in the foregoing method embodiments, which is not repeated here.

In the embodiments provided in the present invention, it should be understood that the disclosed systems, apparatuses and methods may be implemented in other ways. For example, the apparatus embodiments described above are merely illustrative. For example, the division of the units is only a logical function division, and there may be other divisions in actual implementation, for example, multiple units or components may be combined or integrated into another system, or some features may be ignored or not implemented. In addition, the displayed or discussed mutual coupling or direct coupling or communication connection may be indirect coupling or communication connection through interfaces, apparatuses or units, and may be in electrical, mechanical or other forms.

The units serving as separate components may or may not be physically separated, and the components serving as unit display may or may not be physical units, that is, the units may be located in one place or may be distributed on multiple network units. Some or all of the units may be selected according to actual needs to achieve the objectives of the solutions of the embodiments.

Furthermore, all functional units in various embodiments of the present invention may be integrated into one processing unit, may also be physically separated, or two or more of the functional units may be integrated into one unit.

If the integrated unit is implemented in the form of a software functional unit and sold or used as an independent product, it can be stored in a computer readable storage medium. Based on this understanding, the technical solutions of the present invention or the part contributing to the prior art or part of the technical solutions can be essentially embodied in a form of software products. The computer software product can be stored in a computer readable storage medium including a plurality of instructions for making a computer device (which may be a personal computer, a server, or a network device, etc.) execute all or some steps of the methods described in each embodiment of the present invention.

The above descriptions are only specific embodiments of the present invention, but the protection scope of the present invention is not limited thereto. Any simple variations or replacements made by the technical skilled familiar with the prior art within the technical scope disclosed by the present invention shall be covered by the protection scope of the present invention. Therefore, the protection scope of the present invention should be subjected to the protection scope defined by the claims.

### INDUSTRIAL APPLICABILITY

The three-dimensional point cloud of the present invention is an important digital expression of the real world. The three-dimensional point cloud is widely applied to the construction of urban digital maps and plays a role of technical support in a lot of hot researches such as smart cities, unmanned driving, cultural relics protection, etc. The point cloud is acquired by scanning surfaces of objects by the three-dimensional scanning device. A frame of point cloud generally contains millions of points. Each point contains geometric information, color, reflectivity and other attribute information, and is huge in amount of data. The huge data amount of the three-dimensional point cloud brings great challenges to data storage, transmission, etc., so the point cloud compression is very necessary.

1. A point cloud encoding method, comprising:
determining a point set composed of K nearest neighbor points of a current point;
determining a point set composed of L next nearest neighbor points of the current point;
determining a preferred nearest neighbor point set of the current point according to the point set composed of K nearest neighbor points of the current point and the point set composed of L next nearest neighbor points of the current point; and
performing encoding according to the preferred nearest neighbor point set of the current point.

2.-3. (canceled)

4. The method according to claim 1, wherein determining the preferred neighbor point set of the current point according to the point set composed of K nearest neighbor points of the current point and the point set composed of L next nearest neighbor points of the current point comprises:
determining a distance from the center of the point set composed of K nearest neighbor points of the current point to the current point as a first distance;
determining a distance from the center of a point set composed of a total of K-H+I points (i.e. K-H nearest neighbor points in the point set composed of K nearest neighbor points of the current point and I next nearest neighbor points in the point set composed of L next nearest neighbor points of the current point) to the current point as a second distance; and
determining the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when a difference between the first distance and the second distance is greater than a set value, or
determining the point set composed of K nearest neighbor points of the current point as the preferred neighbor point set of the current point when the difference between the first distance and the second distance is less than or equal to the set value.

5. The method according to claim 1, wherein determining the preferred neighbor point set of the current point according to the point set composed of K nearest neighbor points of the current point and the point set composed of L next nearest neighbor points of the current point comprises:
determining the distance from the center of the point set composed of K nearest neighbor points of the current point to the current point as the first distance;
determining the distance from the center of the point set composed of a total of K-H+I points (i.e. K-H nearest neighbor points in the point set composed of K nearest neighbor points of the current point and I next nearest neighbor points in the point set composed of L next nearest neighbor points of the current point) to the current point as the second distance;
determining the point set composed of K nearest neighbor points of the current point as the preferred neighbor point set of the current point when the difference between the first distance and the second distance is less than or equal to the set value, or
when the difference between the first distance and the second distance is greater than the set value:
determining a minimum cost value of the point set composed of K nearest neighbor points of the current point as a first cost value;
determining a minimum cost value of the point set composed of a total of K-H+I points (i.e. K-H nearest neighbor points in the point set composed of K nearest neighbor points of the current point and I next nearest neighbor points in the point set composed of L next nearest neighbor points of the current point) as a second cost value;
determining the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when the second cost value is less than the first cost value, or
determining the point set composed of K nearest neighbor points of the current point as the preferred neighbor point set of the current point when the second cost value is greater than or equal to the first cost value.

6. The method according to claim 1, wherein performing encoding according to the preferred neighbor point set of the current point comprises:
determining a weighted mean of reconstructed attribute values of all points in the preferred neighbor point set of the current point as a candidate predicted value 1, and determining the corresponding mode as a prediction mode 1;
sequentially determining the reconstructed attribute values of all points in the preferred neighbor point set of the current point as candidate predicted value 2 to candidate predicted value N+1, and sequentially determining the corresponding modes as the prediction mode 2 to prediction mode N+1, wherein N is the number of points in the preferred neighbor point set of the current point;
calculating the cost value Jn of the prediction mode 1 to the prediction mode N+1, wherein n is from 1 to N+1, determining the minimum value in Jn as the minimum cost value, and determining the corresponding mode of the minimum cost value as a preferred prediction mode;
determining the predicted value of the current point according to the preferred prediction mode;
determining a predicted residual of the current point according to a difference between the attribute value of the current point and the predicted value of the current point; and
encoding the preferred prediction mode and the predicted residual of the current point.

7. The method according to claim 1, wherein performing encoding according to the preferred neighbor point set of the current point comprises:
determining the weighted mean of the reconstructed attribute values of all points in the preferred neighbor point set of the current point as the candidate predicted value 1, and determining the corresponding mode as the prediction mode 1;
sequentially determining the reconstructed attribute values of all points in the preferred neighbor point set of the current point as the candidate predicted value 2 to candidate predicted value N+1, and sequentially determining the corresponding modes as the prediction mode 2 to prediction mode N+1, wherein N is the number of points in the preferred neighbor point set;
calculating the cost value Jn of the prediction mode 1 to the prediction mode N+1, wherein n is from 1 to N+1, determining the minimum value in Jn as the minimum cost value, and determining the corresponding mode of the minimum cost value as the preferred prediction mode;
determining the predicted value of the current point according to the preferred prediction mode;
determining the predicted residual of the current point according to the difference between the attribute value of the current point and the predicted value of the current point;
encoding the preferred prediction mode and the predicted residual when the difference between the first distance and the second distance is less than or equal to the set value, or
encoding a valid replacement flag, the preferred prediction mode and the predicted residual when the difference between the first distance and the second distance is greater than the set value, and the second cost value is less than the first cost value, or
encoding an invalid replacement flag, the preferred prediction mode and the predicted residual when the difference between the first distance and the second distance is greater than the set value and the second cost value is greater than or equal to the first cost value.

8. A point cloud decoding method, comprising:
determining a point set composed of K nearest neighbor points of a current point;
determining a point set composed of L next nearest neighbor points of the current point;
determining a preferred nearest neighbor point set of the current point according to the point set composed of K nearest neighbor points of the current point and the point set composed of L next nearest neighbor points of the current point; and
performing decoding according to the preferred nearest neighbor point set of the current point.

9.-10. (canceled)

11. The method according to claim 8, wherein determining the preferred neighbor point set of the current point according to the point set composed of K nearest neighbor points of the current point and the point set composed of L next nearest neighbor points of the current point comprises:
determining a distance from the center of the point set composed of K nearest neighbor points of the current point to the current point as a first distance;
determining a distance from the center of a point set composed of a total of K-H+I points (i.e. K-H nearest neighbor points in the point set composed of K nearest neighbor points of the current point and I next nearest neighbor points in the point set composed of L next nearest neighbor points of the current point) to the current point as a second distance;
determining the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when a difference between the first distance and the second distance is greater than a set value, or
determining the point set composed of K nearest neighbor points of the current point as the preferred neighbor point set of the current point when the difference between the first distance and the second distance is less than or equal to the set value.

12. The method according to claim 8, wherein determining the preferred neighbor point set of the current point according to the point set composed of K nearest neighbor points of the current point and the point set composed of L next nearest neighbor points of the current point comprises:
determining the distance from the center of the point set composed of the K nearest neighbor points of the current point to the current point as the first distance;
determining the distance from the center of the point set composed of a total of K-H+I points (i.e. K-H nearest neighbor points in the point set composed of K nearest neighbor points of the current point and I next nearest neighbor points in the point set composed of L next nearest neighbor points of the current point) to the current point as the second distance; and
determining the point set composed of K nearest neighbor points of the current point as the preferred neighbor point set of the current point when the difference between the first distance and the second distance is less than or equal to the set value, or
determining the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when the difference between the first distance and the second distance is greater than the set value and the replacement flag is a valid replacement flag, or
determining the point set composed of K nearest neighbor points of the current point as the preferred neighbor point set of the current point when the difference between the first distance and the second distance is greater than the set value and the replacement flag is an invalid replacement flag.

13. The method according to claim 8, wherein performing decoding according to the preferred neighbor point set of the current point comprises:
determining a predicted value of the current point according to the preferred prediction mode and the preferred neighbor point set; and
determining a reconstructed attribute value of the current point according to a sum of the predicted value of the current point and the predicted residual of the current point.

14. (canceled)

15. A point cloud encoding device, comprising:
a first determination module used to determine a point set composed of K nearest neighbor points of a current point;
a second determination module used to determine a point set composed of L next nearest neighbor points of the current point;
a third determination module used to determine a preferred nearest neighbor point set of the current point according to the point set composed of K nearest neighbor points of the current point and the point set composed of L next nearest neighbor points of the current point; and
an encoding module used to perform encoding according to the preferred nearest neighbor point set of the current point.

16.-17. (canceled)

18. The encoding device according to claim 15, wherein the third determination module is specifically used to:
determine a distance from the center of the point set composed of K nearest neighbor points of the current point to the current point as a first distance;
determine a distance from the center of a point set composed of a total of K-H+I points (i.e. K-H nearest neighbor points in the point set composed of K nearest neighbor points of the current point and I next nearest neighbor points in the point set composed of L next nearest neighbor points of the current point) to the current point as a second distance; and
determine the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when a difference between the first distance and the second distance is greater than a set value, or
determine the point set composed of K nearest neighbor points of the current point as the preferred neighbor point set of the current point when the difference between the first distance and the second distance is less than or equal to the set value.

19. The encoding device according to claim 10, wherein the third determination module is specifically used to:
determine the distance from the center of the point set composed of K nearest neighbor points of the current point to the current point as the first distance;
determine the distance from the center of the point set composed of a total of K-H+I points (i.e. K-H nearest neighbor points in the point set composed of K nearest neighbor points of the current point and I next nearest neighbor points in the point set composed of L next nearest neighbor points of the current point) to the current point as the second distance;
determine the point set composed of K nearest neighbor points of the current point as the preferred neighbor point set of the current point when the difference between the first distance and the second distance is less than or equal to the set value, or
when the difference between the first distance and the second distance is greater than the set value:
determine a minimum cost value of the point set composed of K nearest neighbor points of the current point as a first cost value;
determine a minimum cost value of the point set composed of a total of K-H+I points (i.e. K-H nearest neighbor points in the point set composed of K nearest neighbor points of the current point and I next nearest neighbor points in the point set composed of L next nearest neighbor points of the current point) as a second cost value; and
determine the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when the second cost value is less than the first cost value, or
determine the point set composed of K nearest neighbor points of the current point as the preferred neighbor point set of the current point when the second cost value is greater than or equal to the first cost value.

20. The encoding device according to claim 15, wherein the encoding module is specifically used to:
determine a weighted mean of reconstructed attribute values of all points in the preferred neighbor point set of the current point as a candidate predicted value 1, and determine the corresponding mode as a prediction mode 1;
sequentially determine the reconstructed attribute values of all points in the preferred neighbor point set of the current point as candidate predicted value 2 to candidate predicted value N+1, and determine the corresponding modes as the prediction mode 2 to prediction mode N+1, wherein N is the number of points in the preferred neighbor point set;
calculate a cost value Jn of the prediction mode 1 to the prediction mode N+1, wherein n is from 1 to N+1, determine the minimum value in Jn as the minimum cost value, and determine the corresponding mode of the minimum cost value as an preferred prediction mode;
determine the predicted value of the current point according to the preferred prediction mode;
determine a predicted residual of the current point according to a difference between the attribute value of the current point and the predicted value of the current point; and
encode the preferred prediction mode and the predicted residual.

21. The encoding device according to claim 15, wherein the encoding module is specifically used to:
determine the weighted mean of the reconstructed attribute values of all points in the preferred neighbor point set of the current point as the candidate predicted value 1, and determine the corresponding mode as a prediction mode 1;
sequentially determine the reconstructed attribute values of all points in the preferred neighbor point set of the current point as the candidate predicted value 2 to candidate predicted value N+1, and sequentially determine the corresponding mode as the prediction mode 2 to prediction mode N+1, wherein N is the number of points in the preferred neighbor point set;
calculate the cost value Jn of the prediction mode 1 to the prediction mode N+1, wherein n is from 1 to N+1, determine the minimum value in Jn as the minimum cost value, and determine the corresponding mode of the minimum cost value as the preferred prediction mode;
determine the predicted value of the current point according to the preferred prediction mode;
determine the predicted residual of the current point according to the difference between the attribute value of the current point and the predicted value of the current point; and
encode the preferred prediction mode and the predicted residual when the difference between the first distance and the second distance is less than or equal to the set value, or
encode a valid replacement flag, the preferred prediction mode and the predicted residual when the difference between the first distance and the second distance is greater than the set value, and the second cost value is less than the first cost value, or
encode an invalid replacement flag, the preferred prediction mode and the predicted residual when the difference between the first distance and the second distance is greater than the set value and the second cost value is greater than or equal to the first cost value.

22. A point cloud decoding device, comprising:
a first determination module used to determine a point set composed of K nearest neighbor points of a current point;
a second determination module used to determine a point set composed of L next nearest neighbor points of the current point;
a third determination module used to determine a preferred nearest neighbor point set of the current point according to the point set composed of K nearest neighbor points of the current point and the point set composed of L next nearest neighbor points of the current point; and
a decoding module used to perform decoding according to the preferred nearest neighbor point set of the current point.

23.-24. (canceled)

25. The decoding device according to claim 22, wherein the third determination module is specifically used to:
determine a distance from the center of the point set composed of K nearest neighbor points of the current point to the current point as a first distance;
determine a distance from the center of a point set composed of a total of K-H+I points (i.e. K-H nearest neighbor points in the point set composed of K nearest neighbor points of the current point and I next nearest neighbor points in the point set composed of L next nearest neighbor points of the current point) to the current point as a second distance; and
determine the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when a difference between the first distance and the second distance is greater than a set value, or
determine the point set composed of K nearest neighbor points of the current point as the preferred neighbor point set of the current point when the difference between the first distance and the second distance is less than or equal to the set value.

26. The decoding device according to claim 22, wherein the third determination module is specifically used to:
determine the distance from the center of the point set composed of the K nearest neighbor points of the current point to the current point as the first distance;
determine the distance from the center of the point set composed of a total of K-H+I points (i.e. K-H nearest neighbor points in the point set composed of K nearest neighbor points of the current point and I next nearest neighbor points in the point set composed of L next nearest neighbor points of the current point) to the current point as the second distance; and
determine the point set composed of K nearest neighbor points of the current point as the preferred neighbor point set of the current point when the difference between the first distance and the second distance is less than or equal to the set value, or
determine the point set composed of a total of K-H+I points (i.e. K-H nearest neighbor points in the point set composed of K nearest neighbor points of the current point and I next nearest neighbor points in the point set composed of L next nearest neighbor points of the current point) as the preferred neighbor point set of the current point when the difference between the first distance and the second distance is greater than the set value and the replacement flag is a valid replacement flag, or
determine the point set composed of K nearest neighbor points of the current point as the preferred neighbor point set of the current point when the difference between the first distance and the second distance is greater than the set value and the replacement flag is an invalid replacement flag.

27. The decoding device according to claim 22, wherein the decoding module is specifically used to:
determine a predicted value of the current point according to the preferred prediction mode and the preferred neighbor point set; and
determine the reconstructed attribute value of the current point according to a sum of the predicted value of the current point and the predicted residual of the current point.

28. (canceled)
